(19) United States
(12) Patent Application Publication
(10) Pub. No.: US 2026/0047742 A1
(43) Pub. Date: Feb. 19, 2026

(54) METHOD FOR LOADING DISHES

(71) Applicant: WHIRLPOOL CORPORATION, BENTON HARBOR, MI (US)

(72) Inventors: BENJAMIN N. FULBRIGHT, BERRIEN SPRINGS, MI (US); CHARLES E. NEARPASS, BERRIEN SPRINGS, MI (US); THOMAS M. O'BRIEN, SAINT JOSEPH, MI (US); ANTONY MARK RAPPETTE, BENTON HARBOR, MI (US)

(21) Appl. No.: 18/802,615

(22) Filed: Aug. 13, 2024

(51) Int. Cl. A47L 15/42; A47L 15/00; G06F 3/04847; G06T 7/60; G06T 11/60; G06V 10/70

(52) U.S. Cl. CPC A47L 15/4295; G06F 3/04847; G06T 7/60; G06T 11/60; G06V 10/70; A47L 15/0049; A47L 2301/06; A47L 2301/08; A47L 2401/04; G06T 2200/24

(57) ABSTRACT

A method of loading dishes within at least one or more racks of a dishwasher using a mobile device having an imager, a user interface, and a processor. The method further includes capturing an image of a subset of dishes, determining a loading pattern of the subset of dishes based on at least one dish parameter of the subset of dishes and at least one rack parameter of the one or more racks, and providing the loading pattern as an image comprising the at least one or more racks and the subset of dishes.

### TECHNICAL FIELD

The description generally relates to a method for loading dishes within a dishwasher.

### BACKGROUND

Contemporary appliances for use in a typical household include a cabinet with an interior tub, drum, or the like at least partially defining a treating chamber into which articles can be placed for treatment according to an automatic cycle of operation. Such articles can include kitchenware, glassware, or clothing items in some examples. These appliances, such as dishwashers, typically include one or more racks for supporting articles for treatment.

### BRIEF DESCRIPTION

The disclosure relates to a method of loading dishes within a dishwasher using a mobile device having an imager, a user interface, and a processor, the dishwasher having a tub at least partially defining a treating chamber, with an access opening, and at least one or more racks positioned within the treating chamber, the method comprising: capturing, with the imager of the mobile device, an image of a set of dishes; determining, at the processor of the mobile device, a loading pattern of at least a subset of dishes of the set of dishes based on at least one dish parameter of the subset of dishes and at least one rack parameter of the one or more racks; and providing, at the user interface, the loading pattern as an image comprising the at least one or more racks and the subset of dishes.

### BRIEF DESCRIPTION OF THE DRAWINGS

In the drawings:

FIG. 1 is a right-side perspective view of an automatic dishwasher having multiple systems for implementing an automatic cycle of operation.

FIG. 2 is a schematic view of the dishwasher of FIG. 1 and illustrating at least some of the plumbing and electrical connections between at least some of systems.

FIG. 3 is a schematic view of a controller of the dishwasher of FIGS. 1 and 2.

FIG. 4 is a schematic diagram of inputs and outputs of a mobile device.

FIG. 5 is a view of a user interface of a mobile device illustrating a subset of dishes.

FIG. 6 is a view of the user interface of the mobile device illustrating an image of the dishwasher of FIG. 1.

FIG. 7 is a view of the user interface of the mobile device illustrating an image of loaded racks of the dishwasher of FIG. 2.

FIG. 8 is a schematic diagram of a method of loading dishes within the dishwasher of FIG. 1.

### DETAILED DESCRIPTION

Conventional home appliances, such as dishwashers, rely on a user manually loading the dishes. However, users rarely consult washing instructions associated with the dishes to be washed or the instructions listed on the manual of the dishwasher to load the dishes. Performance of the dishwasher can be impacted due to incorrect loading of the dishes. These impacts can include decrease washing quality, less than optimal resource consumption (water, energy, detergent, etc.), and increased time consumption. Sometimes, improper loading, such as loading dishes onto wrong racks (e.g., top or bottom), at a wrong location on a rack, oriented in wrong directions, and/or loading handwash objects into the dishwasher can cause damage to the dishes. In extreme cases of improperly loaded dishes or utensils, the lifetime of the dishwasher or portions of the dishwasher can be shortened. In these instances, it may be desirable for the user to utilize a mobile device which can show a custom loading pattern based on at least a subset of dirty dishes the user has to wash. That is, the user can input the articles for treatment into a mobile device. The mobile device, knowing the type of dishwasher the user is implementing, can provide a loading pattern based on the input from the user.

Features, advantages, and aspects of the present disclosure are set forth or apparent from consideration of the following detailed description, drawings, and claims. Moreover, the following detailed description is exemplary and intended to provide explanation without limiting the scope of the disclosure as claimed.

As used herein, the terms “first,” “second,” “third,” or the like can be used interchangeably to distinguish one component from another and are not intended to signify location or importance of the individual components. In addition, the singular forms “a,” “an,” and “the” include plural references unless the context clearly dictates otherwise.

Here and throughout the specification and claims, range limitations are combined, and interchanged. Such ranges are identified and include all the sub-ranges contained therein unless context or language indicates otherwise. For example, all ranges disclosed herein are inclusive of the endpoints, and the endpoints are independently combinable with each other.

All directional references (e.g., radial, axial, proximal, distal, upper, lower, upward, downward, left, right, lateral, front, back, top, bottom, above, below, vertical, horizontal, clockwise, counterclockwise, upstream, downstream, forward, aft, etc.) are only used for identification purposes to aid the reader's understanding of the present disclosure, and do not create limitations, particularly as to the position, orientation, or use of aspects of the disclosure described herein. Connection references (e.g., attached, coupled, secured, fastened, connected, and joined) are to be construed broadly and can include intermediate members between a collection of elements and relative movement between elements unless otherwise indicated. As such, connection references do not necessarily infer that two elements are directly connected and in fixed relation to one another. The exemplary drawings are for purposes of illustration only and the dimensions, positions, order, and relative sizes reflected in the drawings attached hereto can vary.

Additionally, as used herein, a “controller” or “controller module” can include a component configured or adapted to provide instruction, control, operation, or any form of communication for operable components to effect the operation thereof. A controller module can include any known processor, microcontroller, or logic device, including, but not limited to: field programmable gate arrays (FPGA), an application specific integrated circuit (ASIC), a proportional controller (P), a proportional integral controller (PI), a proportional derivative controller (PD), a proportional integral derivative controller (PID controller), a hardware-accelerated logic controller (e.g. for encoding, decoding, transcoding, etc.), or the like, or a combination thereof. Non-limiting examples of a controller module can be configured or adapted to run, operate, or otherwise execute program code to effect operational or functional outcomes, including carrying out various methods, functionality, processing tasks, calculations, comparisons, sensing or measuring of values, or the like, to enable or achieve the technical operations or operations described herein. The operation or functional outcomes can be based on one or more inputs, stored data values, sensed or measured values, true or false indications, or the like. While “program code” is described, non-limiting examples of operable or executable instruction sets can include routines, programs, objects, components, data structures, algorithms, etc., that have the technical effect of performing particular tasks or implement particular abstract data types.

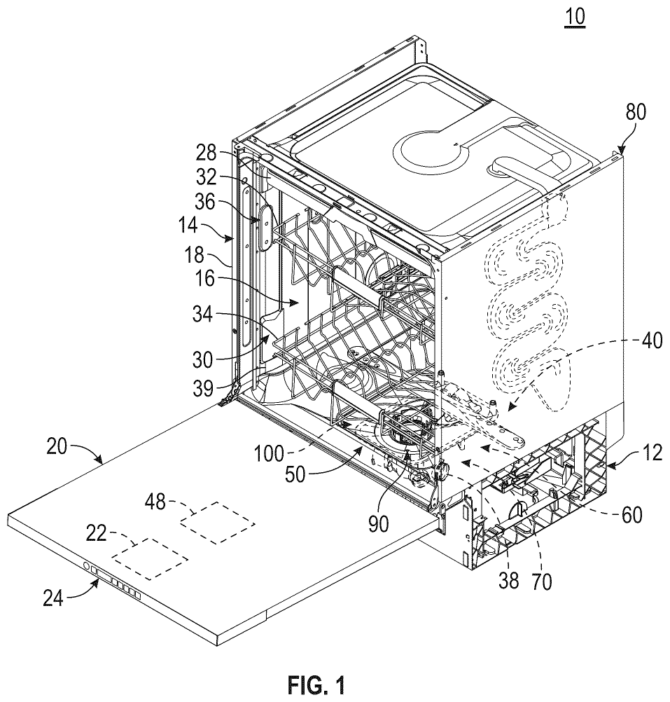

FIG. 1 illustrates an automatic dishwasher 10 capable of implementing an automatic cycle of operation to treat dishes. As used in this description, the term “dish(es)” is intended to be generic to any item, single or plural, that can be treated in the dishwasher 10, including, without limitation, dishes, plates, pots, bowls, pans, glassware, and silverware. As illustrated, the dishwasher 10 is a built-in dishwasher implementation, which is designed for mounting under a countertop. However, this description is applicable to other dishwasher implementations such as a stand-alone, drawer-type or a sink-type, for example.

The dishwasher 10 has a variety of systems, some of which are controllable, to implement the automatic cycle of operation. A chassis is provided to support the variety of systems needed to implement the automatic cycle of operation. As illustrated, for a built-in implementation, the chassis includes a frame in the form of a base 12 on which is supported an open-faced tub 14, which at least partially defines a treating chamber 16, having an open face 18, for receiving the dishes. A closure in the form of a door assembly 20 is pivotally mounted to the base 12 for movement between opened and closed positions to selectively open and close the open face 18 of the tub 14. Thus, the door assembly 20 provides selective accessibility to the treating chamber 16 for the loading and unloading of dishes or other items.

The chassis, as in the case of the built-in dishwasher implementation, can be formed by other parts of the dishwasher 10, like the tub 14 and the door assembly 20, in addition to a dedicated frame structure, like the base 12, with them all collectively forming a uni-body frame to which the variety of systems are supported. In other implementations, like the drawer-type dishwasher, the chassis can be a tub that is slidable relative to a frame, with the closure being a part of the chassis or the countertop of the surrounding cabinetry. In a sink-type implementation, the sink forms the tub and the cover closing the open top of the sink forms the closure. Sink-type implementations are more commonly found in recreational vehicles.

The systems supported by the chassis, while essentially limitless, can include dish holding system 30, spray system 40, recirculation system 50, drain system 60, water supply system 70, drying system 80, heating system 90, and filter system 100. These systems are used to implement one or more treating cycles of operation for the dishes, for which there are many, and one of which includes a traditional automatic wash cycle.

A basic traditional automatic wash cycle of operation has a wash phase, where a detergent/water mixture is recirculated and then drained, which is then followed by a rinse phase where water alone or with a rinse agent is recirculated and then drained. An optional drying phase can follow the rinse phase. More commonly, the automatic wash cycle has multiple wash phases and multiple rinse phases. The multiple wash phases can include a pre-wash phase where water, with or without detergent, is sprayed or recirculated on the dishes, and can include a dwell or soaking phase. There can be more than one pre-wash phases. A wash phase, where water with detergent is recirculated on the dishes, follows the pre-wash phases. There can be more than one wash phase; the number of which can be sensor controlled based on the amount of sensed soils in the wash liquid. One or more rinse phases will follow the wash phase(s), and, in some cases, come between wash phases. The number of wash phases can also be sensor controlled based on the amount of sensed soils in the rinse liquid. The wash phases and rinse phases can include the heating of the water, even to the point of one or more of the phases being hot enough for long enough to sanitize the dishes. A drying phase can follow the rinse phase(s). The drying phase can include a drip dry, heated dry, condensing dry, air dry or any combination.

A controller 22 can also be included in the dishwasher 10 and operably couples with and controls the various components of the dishwasher 10 to implement the cycle of operation. The controller 22 can be located within the door assembly 20 as illustrated, or it can alternatively be located somewhere within the chassis. The controller 22 can also be operably coupled with a control panel or user interface 24 for receiving user-selected inputs and communicating information to the user. The user interface 24 can include operational controls such as dials, lights, switches, and displays enabling a user to input commands, such as a cycle of operation, to the controller 22 and receive information.

The dish holding system 30 can include any suitable structure for holding dishes within the treating chamber 16. Exemplary dish holders are illustrated in the form of upper dish racks 32 and lower dish rack 34, commonly referred to as “racks”, which are located within the treating chamber 16. The upper dish racks 32 and the lower dish rack 34 are typically mounted for slidable movement in and out of the treating chamber 16 through the open face 18 for ease of loading and unloading. Drawer guides/slides/rails 36 are typically used to slidably mount the upper dish rack 32 to the tub 14. The lower dish rack 34 typically has wheels or rollers 38 that roll along rails 39 formed in sidewalls of the tub 14 and onto the door assembly 20, when the door assembly 20 is in the opened position.

Dedicated dish holders can also be provided. One such dedicated dish holder is a third level rack 28 located above the upper dish rack 32. Like the upper dish rack 32, the third level rack is slideably mounted to the tub 14 with drawer guides/slides/rails 36. The third level rack 28 is typically used to hold utensils, such as tableware, spoons, knives, spatulas, etc., in an on-the-side or flat orientation. However, the third level rack 28 is not limited to holding utensils.

Another dedicated dish holder can be a silverware basket (not shown), which is typically carried by one of the upper or lower dish racks 32, 34 or mounted to the door assembly 20. The silverware basket typically holds utensils and the like in an upright orientation as compared to the on-the-side or flat orientation of the third level rack 28.

A dispenser assembly 48 is provided to dispense treating chemistry, e.g. detergent, anti-spotting agent, etc., into the treating chamber 16. The dispenser assembly 48 can be mounted on an inner surface of the door assembly 20, as shown, or can be located at other positions within the chassis. The dispenser assembly 48 can dispense one or more types of treating chemistries. The dispenser assembly 48 can be a single-use dispenser or a bulk dispenser, or a combination of both.

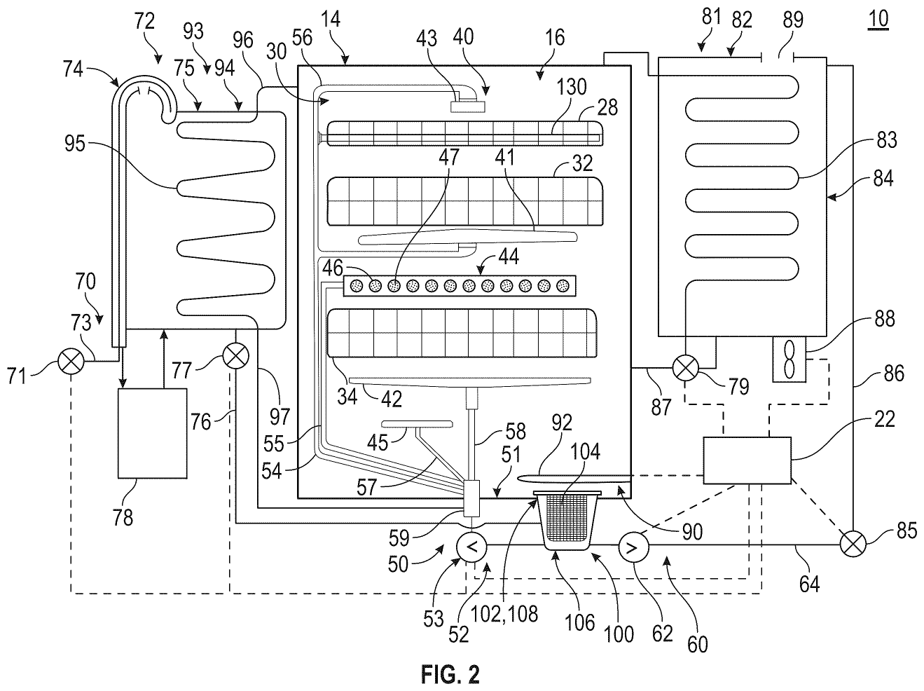

Turning to FIG. 2, the spray system 40 is provided for spraying liquid in the treating chamber 16 and can have a set of spray assemblies or sprayers 41-45, 130, some of which can be dedicated to a particular one of the dish holders, to a particular area of a dish holder, to a particular type of cleaning, or to a particular level of cleaning, etc. The set of sprayers 41-45, 130 can be fixed or movable, such as rotating, relative to the treating chamber 16 or dish holder. Six exemplary sprayers are illustrated in the set of sprayers 41-45, 130 and include an upper spray arm 41, a lower spray arm 42, a third level sprayer 43, a deep-clean sprayer 44, a spot sprayer 45, and a tube sprayer 130. The upper spray arm 41 and lower spray arm 42 are rotating spray arms, located below the upper dish rack 32 and lower dish rack 34, respectively, and rotate about a generally centrally located and vertical axis. The third level sprayer 43 is located above the third-level rack 28. The third level sprayer 43 is illustrated as being fixed, but could move, such as by rotating. In addition to the third level sprayer 43 or in place of the third level sprayer 43, the tube sprayer 130 can be located at least in part below a portion of the third-level rack 28. The tube sprayer 130 is illustrated as a fixed tube, carried by the third-level rack 28, but could be movable, such as by rotating about a longitudinal axis.

The deep-clean sprayer 44 is a manifold extending along a rear wall of the tub 14 and has multiple nozzles 46, with multiple apertures 47, generating an intensified and/or higher-pressure spray than the upper spray arm 41, the lower spray arm 42, or the third level sprayer 43. The nozzles 46 can be fixed or move, such as by rotating. The spray emitted by the deep-clean sprayer 44 defines a deep clean zone, which, as illustrated, would be disposed along a rear side of the lower dish rack 34. Thus, dishes for deep cleaning, such as dishes with baked-on food, can be located in the lower dish rack 34 to face the deep-clean sprayer 44. The deep-clean sprayer 44, while illustrated as only one unit on a rear wall of the tub 14 could comprises multiple units and/or extend along multiple portions, including different walls, of the tub 14, and can be provide above, below, or beside any of the dish holders where deep-cleaning is desired.

The spot sprayer 45, like the deep-clean sprayer, can emit an intensified and/or higher-pressure spray, especially to a discrete location within one of the dish holders. While the spot sprayer 45 is shown below the lower dish rack 34, it could be adjacent any part of any dish holder or along any wall of the tub 14 where special cleaning is desired. In the illustrated location below the lower dish rack 34, the spot sprayer 45 can be used independently of or in combination with the lower spray arm 42. The spot sprayer 45 can be fixed or can move, such as by rotating.

The upper spray arm 41, the lower spray arm 42, the third level sprayer 43, the deep-clean sprayer 44, the spot sprayer 45, and the tube sprayer 130 are illustrative examples of suitable sprayers and are not meant to be limiting as to the type of suitable sprayers in the set of sprayers 41-45, 130.

The recirculation system 50 recirculates the liquid sprayed into the treating chamber 16 by the sprayers of the spray system 40 back to the sprayers to form a recirculation loop or circuit by which liquid can be repeatedly and/or continuously sprayed onto dishes in the dish holders. The recirculation system 50 can include a sump 51 and a pump assembly 52. The sump 51 collects the liquid sprayed in the treating chamber 16 and can be formed by a sloped or recessed portion of a bottom wall of the tub 14. The pump assembly 52 can include one or more pumps such as a recirculation pump 53. The sump 51 can also be a separate module that is affixed to the bottom wall and includes the pump assembly 52.

Multiple liquid supply conduits 54, 55, 56, 57, 58 fluidly couple the set of sprayers 41-45, 130 to the recirculation pump 53. A recirculation valve 59 can selectively fluidly couple each of the conduits 54-58 to the recirculation pump 53. While each sprayer 41-45, 130 is illustrated as having a corresponding dedicated supply conduit 54-58 one or more subsets, comprising multiple sprayers from the total group of sprayers 41-45, 130 can be supplied by the same conduit, negating the need for a dedicated conduit for each sprayer. For example, a single conduit can supply the upper spray arm 41 and the third level sprayer 43. Another example is that the sprayer 130 is supplied liquid by the conduit 56, which also supplies the third level sprayer 43.

The recirculation valve 59, while illustrated as a single valve, can be implemented with multiple valves. Additionally, one or more of the conduits 54-58 can be directly coupled to the recirculation pump 53, while one or more of the other conduits 54-58 can be selectively coupled to the recirculation pump 53 with one or more valves. There are essentially an unlimited number of plumbing schemes to connect the recirculation system 50 to the spray system 40. The illustrated plumbing is not limiting.

The drain system 60 drains liquid from the treating chamber 16. The drain system 60 includes a drain pump 62 fluidly coupling the treating chamber 16 to a drain line 64. As illustrated the drain pump 62 fluidly couples the sump 51 to the drain line 64.

While separate recirculation and drain pumps 53, 62 are illustrated, a single pump can be used to perform both the recirculating and the draining functions. Alternatively, the drain pump 62 can be used to recirculate liquid in combination with the recirculation pump 53. When both a recirculation pump 53 and drain pump 62 are used, the drain pump 62 can be more robust than the recirculation pump 53 as the drain pump 62 tends to have to remove solids and soils from the sump 51, unlike the recirculation pump 53, which may recirculate liquid which has solids and soils filtered away to some extent.

The water supply system 70 is provided for supplying fresh water to the dishwasher 10 from a household water supply via a household water valve 71. The water supply system 70 includes a water supply unit 72 having a water supply conduit 73 with a siphon break 74. While the water supply conduit 73 can be directly fluidly coupled to the tub 14 or any other portion of the dishwasher 10, the water supply conduit 73 is shown fluidly coupled to a supply tank 75, which can store the supplied water prior to use. The supply tank 75 is fluidly coupled to the sump 51 by a supply line 76, which can include a controllable valve 77 to control when water is released from the supply tank 75 to the sump 51.

The supply tank 75 can be conveniently sized to store a predetermined volume of water, such as a volume for a phase of the cycle of operation, which is commonly referred to as a “charge” of water. The storing of the water in the supply tank 75 prior to use is beneficial in that the water in the supply tank 75 can be “treated” in some manner, such as softening or heating prior to use.

A water softener 78 is provided with the water supply system 70 to soften the fresh water. The water softener 78 is shown fluidly coupling the water supply conduit 73 to the supply tank 75 so that the supplied water automatically passes through the water softener 78 on the way to the supply tank 75. However, the water softener 78 could directly supply the water to any other part of the dishwasher 10 than the supply tank 75, including directly supplying the tub 14. Alternatively, the water softener 78 can be fluidly coupled downstream of the supply tank 75, such as in-line with the supply line 76. Wherever the water softener 78 is fluidly coupled, it can be done so with controllable valves, such that the use of the water softener 78 is controllable and not mandatory.

The drying system 80 is provided to aid in the drying of the dishes during the drying phase. The drying system as illustrated includes a condensing assembly 81 having a condenser 82 formed of a serpentine conduit 83 with an inlet fluidly coupled to an upper portion of the tub 14 and an outlet fluidly coupled to a lower portion of the tub 14, whereby moisture laden air within the tub 14 is drawn from the upper portion of the tub 14, passed through the serpentine conduit 83, where liquid condenses out of the moisture laden air and is returned to the treating chamber 16 where it ultimately evaporates or is drained via the drain pump 62. The serpentine conduit 83 can be operated in an open loop configuration, where the air is exhausted to atmosphere, a closed loop configuration, where the air is returned to the treating chamber, or a combination of both by operating in one configuration and then the other configuration.

To enhance the rate of condensation, the temperature difference between the exterior of the serpentine conduit 83 and the moisture laden air can be increased by cooling the exterior of the serpentine conduit 83 or the surrounding air. To accomplish this, an optional cooling tank 84 is added to the condensing assembly 81, with the serpentine conduit 83 being located within the cooling tank 84. The cooling tank 84 is fluidly coupled to at least one of the spray system 40, the recirculation system 50, the drain system 60, or the water supply system 70 such that liquid can be supplied to the cooling tank 84. The liquid provided to the cooling tank 84 from any of the systems 40-70 can be selected by source and/or by phase of cycle of operation such that the liquid is at a lower temperature than the moisture laden air or even lower than the ambient air.

As illustrated, the liquid is supplied to the cooling tank 84 by the drain system 60. A valve 85 fluidly connects the drain line 64 to a supply conduit 86 fluidly coupled to the cooling tank 84. A return conduit 87 fluidly connects the cooling tank 84 back to the treating chamber 16 via a return valve 79. In this way, a fluid circuit is formed by the drain pump 62, the drain line 64, the valve 85, the supply conduit 86, the cooling tank 84, the return valve 79, and the return conduit 87 through which liquid can be supplied from the treating chamber 16 to the cooling tank 84, and back to the treating chamber 16. Alternatively, the supply conduit 86 could fluidly couple to the drain line 64 if re-use of the water is not desired.

To supply cold water from the household water supply via the household water valve 71 to the cooling tank 84, the water supply system 70 would first supply cold water to the treating chamber 16, then the drain system 60 would supply the cold water in the treating chamber 16 to the cooling tank 84. It should be noted that the supply tank 75 and cooling tank 84 could be configured such that one tank performs both functions.

The drying system 80 can use ambient air, instead of or in addition to cold water, to cool the exterior of the serpentine conduit 83. In such a configuration, a blower 88 is connected to the cooling tank 84 and can supply ambient air to the interior of the cooling tank 84. The cooling tank 84 can have a vented top 89 to permit the passing through of the ambient air to allow for a steady flow of ambient air blowing over the serpentine conduit 83.

The cooling air from the blower 88 can be used in lieu of the cold water or in combination with the cold water. The cooling air can be used when the cooling tank 84 is not filled with liquid. Advantageously, the use of cooling air or cooling water, or combination of both, can be selected according to the site-specific environmental conditions. If ambient air is cooler than the cold water temperature, then the ambient air can be used. If the cold water is cooler than the ambient air, then the cold water can be used. Energy efficiency and/or cost-effectiveness can also be taken into account when selecting one or both of cooling air or cooling water. The blower 88 can be used to dry the interior of the cooling tank 84 after the water has been drained. Suitable temperature sensors for the cold water and the ambient air can be provided and send their temperature signals to the controller 22, which can determine which of the two is colder at any time or phase of the cycle of operation.

The heating system 90 is provided for heating water used in the cycle of operation. The heating system 90 includes a heater 92, such as an immersion heater, located in the treating chamber 16 at a location where it will be immersed in the water supplied to the treating chamber 16. The heater 92 need not be an immersion heater. The heater 92 can also include an in-line heater located in any of the conduits. There can also be more than one heater 92, including both an immersion heater and an in-line heater.

The heating system 90 can also include a heating circuit 93, which includes a heat exchanger 94, illustrated as a serpentine conduit 95, located within the supply tank 75, with a supply conduit 96 supplying liquid from the treating chamber 16 to the serpentine conduit 95, and a return conduit 97 fluidly coupled to the treating chamber 16. The heating circuit 93 is fluidly coupled to the recirculation pump 53 either directly or via the recirculation valve 59 such that liquid that is heated as part of a cycle of operation can be recirculated through the heat exchanger 94 to transfer the heat to the charge of fresh water residing in the supply tank 75. As various wash phases use liquid that is heated by the heater 92, this heated liquid can then be recirculated through the heating circuit 93 to transfer the heat to the charge of water in the supply tank 75, which can be used in the next phase of the cycle of operation.

A filter system 100 is provided to filter un-dissolved solids from the liquid in the treating chamber 16. The filter system 100 includes a coarse filter 102 and a fine filter 104, which can be a removable basket 106 residing the sump 51, with the coarse filter 102 being a screen 108 circumscribing the removable basket 106. Additionally, the recirculation system 50 can include a rotating filter in addition to or in place of the either or both of the coarse filter 102 and fine filter 104. Other filter arrangements are contemplated, such as an ultrafiltration system.

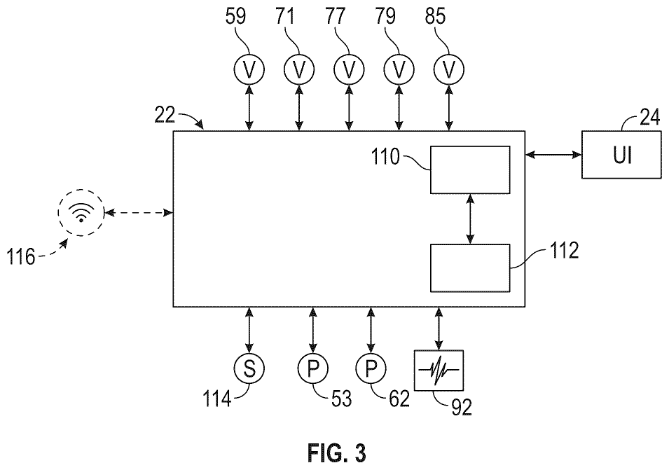

As illustrated schematically in FIG. 3, the controller 22 can be coupled with the heater 92 for heating the wash liquid during a cycle of operation, the drain pump 62 for draining liquid from the treating chamber 16, and the recirculation pump 53 for recirculating the wash liquid during the cycle of operation. The controller 22 can be provided with a memory 110 and a central processing unit (CPU) 112. The memory 110 can be used for storing control software that can be executed by the CPU 112 in completing a cycle of operation using the dishwasher 10 and any additional software. For example, the memory 110 can store one or more pre-programmed automatic cycles of operation that can be selected by a user and executed by the dishwasher 10. The controller 22 can also receive input from one or more sensors 114. Non-limiting examples of sensors that can be communicably coupled with the controller 22 include, to name a few, ambient air temperature sensor, treating chamber temperature sensor, water supply temperature sensor, door open/close sensor, and turbidity sensor to determine the soil load associated with a selected grouping of dishes, such as the dishes associated with a particular area of the treating chamber. The controller 22 can also communicate with the recirculation valve 59, the household water valve 71, the controllable valve 77, the return valve 79, and the valve 85. Optionally, the controller 22 can include or communicate with a wireless communication device 116.

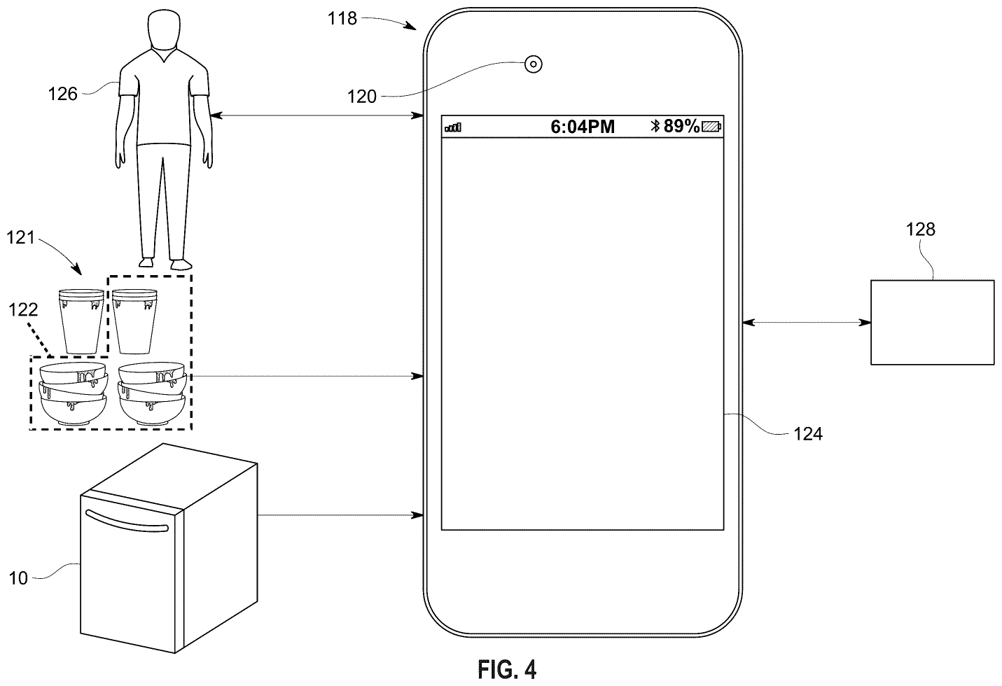

FIG. 4 is a schematic diagram of exemplary inputs and outputs of a mobile device 118. An imager 120 of the mobile device 118 is configured to capture images for use with the mobile device 118. For example, the imager 120 can capture an image of the dishwasher 10, one or more racks, such as the upper dish racks 32, the lower dish rack 34, or the third level rack 28 (FIG. 1), a set of dishes 121, a QR code, or any combination thereof. A user interface 124 permits a user 126 to receive, view, or provide information related to a load size or a cleanliness level of at least a subset of dishes 122 of the set of dishes 121. While illustrated as a portion of the set of dishes 121, it is contemplated that the subset of dishes 122 can include the set of dishes 121. While the mobile device 118 is illustrated and generally described in relation to a mobile phone, it can, for example, comprise a smartphone, a tablet computer, a desktop computer, or a notebook computer.

A processor 128 is configured to receive inputs from the mobile device 118. That is, the processor 128 can receive an input such as, but not limited to, an image. In a non-limiting example, the image can be of the dishwasher 10, one or more of the upper racks 32, the lower rack 34, or the third level rack 28 (FIG. 1), hereinafter referred to as “racks” for convenience, a set of dishes 121, or any combination thereof.

In a non-limiting example, the processor 128 is also configured to receive one or more inputs from a user 126, for example, via the user interface 124 of the mobile device 118. By way of further example, the user 126 can provide a serial number corresponding to a make and model of the dishwasher 10, cycle information, types of dishes in the set of dishes 121 or the subset of dishes 122, size of one or more dishes of the set of dishes 121 or the subset of dishes 122, or any combination thereof.

While the processor 128 is illustrated as a box in FIG. 4, it is understood that the processor 128 can be included in part or in whole within the mobile device 118. The processor 128 can include any suitable processor, suitable programs, neural network, generative artificial intelligence (AI), machine learning, pre-set databases, or executable instructions designed to carry out various methods, functionality, processing tasks, calculations, or the like, to enable or achieve the technical operations or operations described herein. That is, the processor 128 is configured to determine a loading pattern of the set of dishes 121 within the one or more racks 28, 32, 34 of the dishwasher 10. For example, the processor 128 can determine the loading pattern of the set of dishes 121 or the subset of dishes 122 based on at least one dish parameter of the set of dishes 121 or the subset of dishes 122, a dishwasher parameter, and at least one rack parameter of the one or more racks 28, 32, 34.

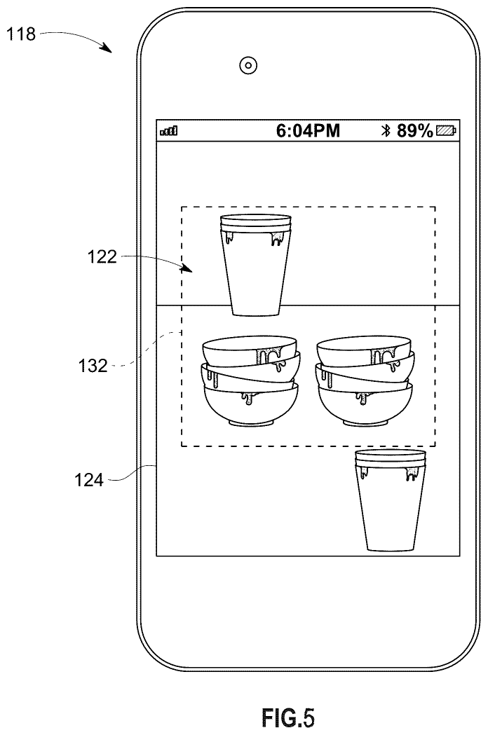

FIG. 5 is a view of the user interface 124 of the mobile device 118 illustrating an image of the subset of dishes 122. A selection box 132 is shown enclosing the subset of dishes 122. The selection box is configured to show the ways the subset of dishes 122 are being considered. That is, the subset of dishes 122 can be refined and expanded based on feedback provided by the user 126 (FIG. 4). For example, the user 126 (FIG. 4) can refine the subset of dishes 122 such that only a portion of a total number of dishes of the set of dishes 121 located outside of the dishwasher 10 are considered by the processor 128 (FIG. 4). While the selection box 132 is shown as substantially rectangular, it is contemplated that the selection box 132 can be any shape. Optionally, a surrounding area outside of the selection box 132 can be shaded to indicate to the user 126 (FIG. 4) that items or dishes from the set of dishes 121 will be excluded from the consideration of the processor 128 (FIG. 4) for the loading pattern. The subset of dishes 122 within the selection box 132 can be used to determine the at least one dish parameter. In a non-limiting example, the at least one dish parameter can include one or more of a size of the dish, a dish type, number of dishes, or a material of the dish. The size of the dish can be, by way of non-limiting example, a diameter of a plate or bowl, a thickness of a glass, a height dimension measured from a top to a bottom, or any combination thereof. The type of the dish can be, by way of non-limiting example, a bowl, a cup, a plate, a pot, a pan, or any combination thereof. The dishes can include, by way of example, one or more of glass, ceramic, metal, plastics, or any combination thereof.

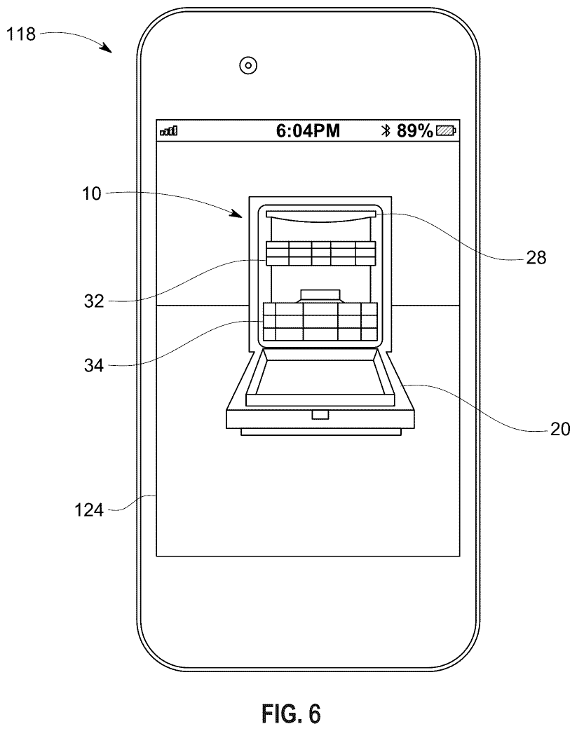

FIG. 6 is a view of the user interface 124 of the mobile device 118 illustrating an image of the dishwasher 10. The dishwasher 10 is shown with the door assembly 20 in an open position such that at least the racks 28, 32, 34 are visible. The image of the dishwasher 10 can be used to determine the at least one rack parameter. In a non-limiting example, the at least one rack parameter includes one or more of a location of the sprayers, a layout of tines, or a height of the one or more racks. Optionally, the image of the dishwasher 10 can be used to determine the dishwasher parameter. In a non-limiting example, the dishwasher parameter includes a make and model of the dishwasher.

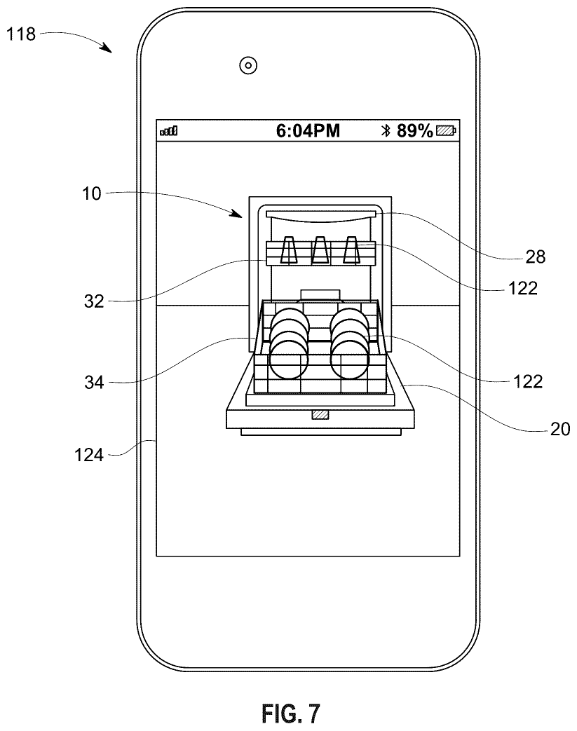

FIG. 7 is a view of the user interface 124 of the mobile device 118 illustrating a loading pattern. The subset of dishes 122 are shown, for example, loaded into the upper and lower dish racks 32, 34 in the loading pattern determined by the processor 128 (FIG. 4). The loading pattern is communicated through the user interface 124 so that the user 126 (FIG. 4) can follow the loading pattern. In a non-limiting example, the loading pattern can be provided at the user interface 124 as an image or an interactive image. Optionally, the interactive image provided at the user interface 124 can include a 3D model of one or more of the racks 28, 32, 34. The interactive image can allow a user 126 to virtually move (e.g., virtually slide the racks 28, 32, 34 into or out of the tub 14), or show/hide (e.g., click on aspects of the dishwasher to hide or show to case viewing of the loading pattern) one or more of the racks 28, 32, 34.

Referring to FIGS. 1-7, during operation, the user 126 can capture the image of the set of dishes 121 located outside of the dishwasher 10. The set of dishes 121, for example, can be located on a counter, kitchen table, or in a sink.

The user 126 can provide information indicative of a make and model of the dishwasher 10. That is, the user can utilize the mobile device 118 to determine a make and model of their dishwasher 10. This can, for example, include inputting a serial number, scanning a QR code, or capturing an image of the dishwasher 10.

Prior to, during, or after inputting information related to the make and model of the dishwasher, the user 126 can input additional information, for example, via the user interface 124. The additional information can include prioritization. For example, the user can choose to prioritize a load size, a cleanliness level, or minimize water usage. In a non-limiting example, the user input of prioritize the load size can correspond to a maximum load size, where the greatest number of dishes from the set of dishes 121 is include in the subset of dishes 122. In a non-limiting example, the loading pattern for the user input of prioritize the load size is configured to fit each dish of the subset of dishes 122.

Alternatively, in a different and non-limiting example, the additional information from the user 126 can be a user input corresponding to a maximum cleanliness level. If the user 126 selects to prioritize the maximum cleanliness level, the processor 128 will consider the loading pattern that includes loading a portion of the set of dishes 121 or the subset of dishes 122 so that the wash cycle has an optimized cleaning coverage. The processor 128, when maximum cleanliness level is selected, can consider one or more of the shape of the set of dishes 121 or the subset of dishes 122, sprayer location within the tub 14, prior feedback related to cleanliness and the location of the dishes of previous cycles, or soil level of the dishes to determine a loading pattern.

Once the set of dishes 121 is input via the imager 120, the information related to the make and model of the dishwasher is input, and any optional additional information is provided, the subset of dishes 122 can be determined.

In one example, the user 126 can expand or refine the set of dishes 121 to determine the subset of dishes 122, to include only a desired selection of the set of dishes 121 to be loaded. Optionally, the set of dishes 121 can be refined by the user via the selection box 132. It is contemplated that in addition to or as an alternative, the user 126 can actively click on one or more dishes of the set of dishes 121 via the user interface 124 to select or de-select dishes from the subset of dishes 122.

In another non-limiting example, the set of dishes 121 can be refined by the processor 128, where the subset of dishes 122 are presented to the user via the user interface 124 or the selection box 132. That is, the processor 128 can consider the dish parameter of the subset of dishes 122, at least one rack parameter of the one or more racks 28, 32, 34, and the dishwasher parameter of the dishwasher 10. The processor 128 then considers the set of dishes 121 and provides the subset of dishes 122. For example, if the set of dishes 121 does not meet pre-determined variables based on at least one of a rack parameter or dishwasher parameter (e.g., the set of dishes 121 will not all fit in the racks 28, 32, 34, or a dish from the set of dishes 121 is too tall for the racks 28, 32, 34) processor can determine the subset of dishes 122 for which the number of dishes in the subset of dishes 122 is less than the number of dishes in the set of dishes 121.

Additionally, or alternatively, the processor 128 can provide an opportunity for the user 126 to select via the user interface 124 the subset of dishes 122 for which the number of dishes in the subset of dishes 122 is less than the number of dishes in the set of dishes 121, until the subset of dishes 122 is within or satisfies the pre-determined variables.

Once the subset of dishes 122 is decided, the processor 128 can provide the loading pattern. The loading pattern can be provided by an image or an interactive image on the user interface 124. From there, the user 126 can use the loading pattern to load the subset of dishes 122 into the racks 28, 32, 34.

Optionally, the user 126 can capture an image of the subset of dishes 122 loaded into one or more of the racks 28, 32, 34. The processor 128 can compare the image of the subset of dishes 122 loaded into one or more of the racks 28, 32, 34 to the loading pattern. If a dish is mis-placed, an optimization suggestion can be provided on the user interface 124. The optimization suggestion can prompt the user 126 to move or reorient a dish identified as mis-placed.

Once the user 126 loads the subset of dishes 122 according to the loading pattern, a cycle of operation of dishwashing can commence. Optionally, the user 126 can provide feedback based on a quality of the wash cycle. The processor 128 can consider this feedback in future cycles of operation to update or otherwise change loading patterns.

Optionally, the user 126 can capture an image of the set of dishes 121 in a kitchen. The processor 128 can compare the image of the set of dishes 121 to predetermined dishwasher parameters and recommend a corresponding model of dishwasher 10 to the user 126. Additionally, or alternatively, the processor 128 can gather data from several images of various sets of dishes or subsets of dishes and compare the gathered data to predetermined dishwasher parameters and recommend a corresponding model of dishwasher to the user 126.

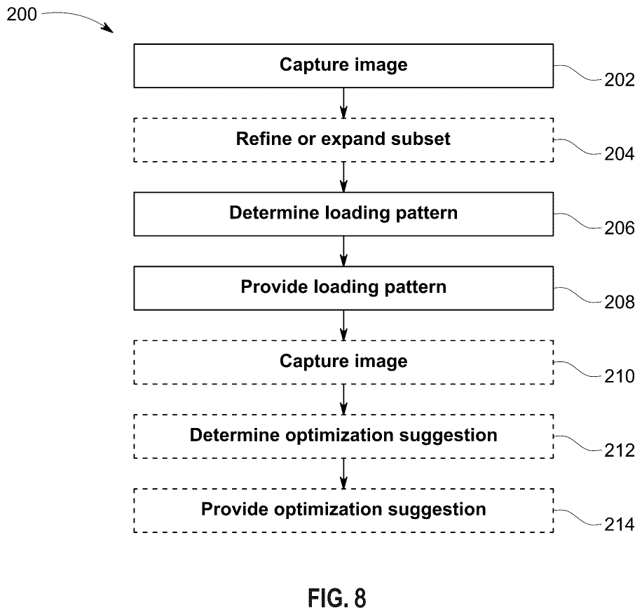

FIG. 8 is a flowchart diagram of a method 200 of loading dishes within the dishwasher 10 of FIG. 1. The method 200 can be utilized to determine the loading pattern of the subset of dishes 122 of FIG. 4, FIG. 5, and FIG. 6. At 202, the image of the set of dishes 121 (FIG. 4) can be captured with the imager 120 (FIG. 4) of the mobile device 118. The set of dishes 121 can include, for example, a group of dishes outside of the dishwasher 10 (FIG. 1). Optionally, at 204 or as a part of 206, the subset of dishes 122 (FIG. 5) can be determined, and can further be refined or expanded based on user feedback or feedback from the processor 128. That is, the user 126 (FIG. 4) can select a larger or smaller subset of dishes 122 out of the total number of the set of dishes 121 outside of the dishwasher 10. At 206, the loading pattern of the subset of dishes 122 can be determined at the processor 128 of the mobile device 118 (FIG. 4). The loading pattern can be based on at least one dish parameter of the subset of dishes 122 and at least one rack parameter of the one or more racks 28, 32, 34. At 208, the loading pattern can be provided as an image or an interactive image at the user interface 124 (FIG. 7). That is, the image includes the subset of dishes 122 loaded into the one or more racks 28, 32, 34.

Optionally, at 210, an image of the subset of dishes 122 (FIG. 7) after loading into the racks 28, 32, 34 of the dishwasher 10 can be captured with the imager 120 (FIG. 4). At 212, an optimization suggestion can be determined at the processor 128 (FIG. 4). The optimization suggestion is determined by the processor 128 which compares the image of the subset of dishes 122 after loading into the racks 28, 32, 34 and the loading pattern proved by the processor 128.

At 214, the optimization suggestion can be provided at the user interface 124 in form of an alert. The alert can be indicative of a mis-placed dish within the racks 28, 32, 34 or a dish not part of the subset of dishes 122, prompting the user 126 to move or remove the dish. Additionally, or alternatively, the alert can indicate that one of more of the racks 28, 32, 34 need to change position or height, a dish is not dishwasher safe, a dish is not loaded in the right orientation, a dish is too tall, or any combination thereof. In a non-limiting example, the warning can be in form of text displayed on the user interface 124 or the warning can be represented as a highlighted dish within the one or more racks 28, 32, 34.

Aspects of the disclosure provide for several benefits, including the mobile application providing the user intuitive and visual instructions for loading dishes into the dishwasher. The user has control over the subset of dishes considered by the processor, meaning, the loading pattern is unique to the subset of dishes selected by the user. This creates an optimized loading pattern tailored to the specific needs of the user. In addition, the mobile application provides a loading pattern which allows for proper operation of the dishwasher, reducing resource consumption and improving wash times.

To the extent not already described, the different features and structures of the various aspects can be used in combination with each other as desired. That one feature cannot be illustrated in all of the aspects is not meant to be construed that it cannot be, but is done for brevity of description. Thus, the various features of the different aspects can be mixed and matched as desired to form new aspects, whether or not the new aspects are expressly described. Combinations or permutations of features described herein are covered by this disclosure.

This written description uses examples to disclose aspects of the disclosure, including the best mode, and also to enable any person skilled in the art to practice aspects of the disclosure, including making and using any devices or systems and performing any incorporated methods. While aspects of the disclosure have been specifically described in connection with certain specific details thereof, it is to be understood that this is by way of illustration and not of limitation. Reasonable variation and modification are possible within the scope of the forgoing disclosure and drawings without departing from the spirit of the disclosure, which is defined in the appended claims.

Further aspects of the disclosure are provided by the following clauses:

A method of loading dishes within a dishwasher using a mobile device having an imager, a user interface, and a processor, the dishwasher having a tub at least partially defining a treating chamber, with an access opening, at least one or more racks positioned within the treating chamber, the method comprising: capturing, with the imager of the mobile device, an image of a set of dishes; determining, at the processor of the mobile device, a loading pattern of at least a subset of dishes of the set of dishes based on at least one dish parameter of the subset of dishes and at least one rack parameter of the one or more racks; and providing, at the user interface, the loading pattern as an image comprising the at least one or more racks and the subset of dishes.

The method of any preceding claim, wherein the determining the loading pattern further comprises determining a dishwasher parameter.

The method of any preceding claim, wherein the at least one rack parameter includes one or more of a location of a sprayer, a layout of tines, or a height of the one or more racks.

The method of any preceding claim, wherein the at least one dish parameter includes one or more of a size of a dish, a dish type, or a material of a dish.

The method of any preceding claim, wherein capturing, with the imager of the mobile device, the image of the set of dishes includes imaging the set of dishes outside of the dishwasher.

The method of any preceding claim, further comprising one of refining or expanding the subset of dishes based on user feedback.

The method of any preceding claim, wherein refining or expanding the subset of dishes includes providing the subset of dishes within a selection box.

The method of any preceding claim, wherein determining the loading pattern comprises determining, at the user interface, the subset of dishes of the set of dishes.

The method of any preceding claim, wherein determining the loading pattern comprises determining, at the processor, a subset of dishes of the set of dishes.

The method of any preceding claim, wherein the processor comprises a neural network, machine learning, or generative Artificial Intelligence.

The method of any preceding claim, wherein the providing, at the user interface, the loading pattern as an image comprising the at least one or more racks and the subset of dishes comprises displaying an image or an interactive image of one or more racks loaded with the subset of dishes on the user interface.

The method of any preceding claim, wherein the interactive image is a 3D model of the one or more racks.

The method of any preceding claim, further comprising capturing one or more images of the subset of dishes after the loading into the one or more racks, determining an optimization suggestion based on the one or more images of the subset of dishes after the loading into the one or more racks, and providing the optimization suggestion.

The method of any preceding claim, wherein the determining the optimization suggestion comprises processing the image of the subset of dishes after loading into the one or more racks through the processor.

The method of any preceding claim, wherein the providing the optimization suggestion comprises displaying one or more warnings on the user interface.

The method of any preceding claim, wherein the one or more warnings are indicative of a mis-placed dish of the subset of dishes.

The method of any preceding claim, wherein the determining the loading pattern of the subset of dishes is based on at least one dish parameter of the subset of dishes, at least one rack parameter of the one or more racks, and a user input.

The method of any preceding claim, wherein the user input includes a load size or a cleanliness level.

The method of any preceding claim, wherein the load size includes a maximum load size and the loading pattern is configured to fit each dish of the subset of dishes.

The method of any preceding claim, wherein the cleanliness level is a maximum cleanliness level and the loading pattern is configured to orient the subset of dishes for an optimized cleaning coverage.

What is claimed is:

1. A method of loading dishes within a dishwasher using a mobile device having an imager, a user interface, and a processor, the dishwasher having a tub at least partially defining a treating chamber, with an access opening, at least one or more racks positioned within the treating chamber, the method comprising:
capturing, with the imager of the mobile device, an image of a set of dishes;
determining, at the processor of the mobile device, a loading pattern of at least a subset of dishes of the set of dishes based on at least one dish parameter of the subset of dishes and at least one rack parameter of the one or more racks; and
providing, at the user interface, the loading pattern as an image comprising the at least one or more racks and the subset of dishes.

2. The method of claim 1, wherein the determining the loading pattern further comprises determining a dishwasher parameter.

3. The method of claim 2, wherein the at least one rack parameter includes one or more of a location of a sprayer, a layout of tines, or a height of the one or more racks.

4. The method of claim 1, wherein the at least one dish parameter includes one or more of a size of a dish, a dish type, or a material of a dish.

5. The method of claim 1, wherein capturing, with the imager of the mobile device, the image of the set of dishes includes imaging the set of dishes outside of the dishwasher.

6. The method of claim 5, further comprising one of refining or expanding the subset of dishes based on user feedback.

7. The method of claim 5, wherein refining or expanding the subset of dishes includes providing the subset of dishes within a selection box.

8. The method of claim 1, wherein determining the loading pattern comprises determining, at the user interface, the subset of dishes of the set of dishes.

9. The method of claim 1, wherein determining the loading pattern comprises determining, at the processor, a subset of dishes of the set of dishes.

10. The method of claim 9, wherein the processor comprises a neural network, machine learning, or generative Artificial Intelligence.

11. The method of claim 1, wherein the providing, at the user interface, the loading pattern as an image comprising the at least one or more racks and the subset of dishes comprises displaying an image or an interactive image of the at least one or more racks loaded with the subset of dishes on the user interface.

12. The method of claim 11, wherein the interactive image is a 3D model of the one or more racks.

13. The method of claim 1, further comprising capturing one or more images of the subset of dishes after the loading into the one or more racks, determining an optimization suggestion based on the one or more images of the subset of dishes after the loading into the one or more racks, and providing the optimization suggestion.

14. The method of claim 13, wherein the determining the optimization suggestion comprises processing the image of the subset of dishes after loading into the one or more racks through the processor.

15. The method of claim 13, wherein the providing the optimization suggestion comprises displaying one or more warnings on the user interface.

16. The method of claim 15, wherein the one or more warnings are indicative of a mis-placed dish of the subset of dishes.

17. The method of claim 1, wherein the determining the loading pattern of the subset of dishes is based on the at least one dish parameter of the subset of dishes, the at least one rack parameter of the at least one or more racks, and a user input.

18. The method of claim 17, wherein the user input includes a load size or a cleanliness level.

19. The method of claim 18, the load size includes a maximum load size and the loading pattern is configured to fit each dish of the subset of dishes.

20. The method of claim 18, wherein the cleanliness level is a maximum cleanliness level and the loading pattern is configured to orient the subset of dishes for an optimized cleaning coverage.
